(19) United States
(12) Patent Application Publication
(10) Pub. No.: US 2010/0048161 A1
(43) Pub. Date: Feb. 25, 2010

(54) METHOD, SYSTEM AND APPARATUSES THEREOF FOR REALIZING EMERGENCY COMMUNICATION SERVICE

(75) Inventors: Xianhui He, Shenzhen (CN); Wei Zhang, Shenzhen (CN); Yong Xie, Shenzhen (CN); Jianjun Wu, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/607,827

(22) Filed: Oct. 28, 2009

Related U.S. Application Data
(63) Continuation of application No. PCT/CN2008/070817, filed on Apr. 25, 2008.

(30) Foreign Application Priority Data
Apr. 28, 2007 (CN) 200710103150.5

(51) Int. Cl. H04M 11/04

(52) U.S. Cl. 455/404.1; 370/328

(57) ABSTRACT

A method and a system for realizing an emergency communication service and apparatuses thereof are provided. The method includes: receiving a message carrying an emergency service indication sent by a user terminal; establishing a bearer link for bearing emergency service signaling and emergency service data; receiving an address obtaining request sent by the user terminal based on the bearer link for bearing the emergency service signaling; delivering to the user terminal a local network communication address allocated for the user terminal and an access point address to an apparatus providing a local network emergency service based on the bearer link; and realizing communication with the apparatus providing a local network emergency service according to the access point address and based on the communication address and the established bearer link. Thus, an emergency communication service processing capability is achieved for the user based on a radio network system.

### CROSS-REFERENCE TO RELATED APPLICATIONS

The application is a continuation of International Application No. PCT/CN2008/070817, filed on Apr. 25, 2008, which claims priority to Chinese Patent Application No. 200710103150.5, filed on Apr. 28, 2007, both of which are hereby incorporated by reference in their entireties.

### FIELD OF THE TECHNOLOGY

The disclosure relates to the field of wireless communication technologies, and more particularly to a method, a system and an apparatus for realizing an emergency communication service.

### BACKGROUND OF THE INVENTION

IP multimedia subsystem (IMS) is a subsystem that supports an IP multimedia service proposed in Release 5 of the 3rd Generation Partnership Project (3GPP). The IMS is a multimedia service control platform on a packet switched (PS) domain, and capable of supporting session and non-session multimedia services, so as to provide a general service platform for future multimedia applications.

FIG. 1 is a block diagram of a basic structure of an existing IMS. The IMS includes a policy control and charging rules function (PCRF) 10, a subscription profile repository (SPR) 20, a policy and charging enforcement function (PCEF) 30, a call session control function (CSCF) 40, a home subscriber server (HSS) 60, and a service location function (SLF) 70.

The PCRF 10 is adapted to determine service policy and charging control (PCC) rules according to restrictions of a user accessing a network, operator policies, user subscription data, and service information currently handled by the user. The user subscription data is obtained from the SPR 20, and the PCC rules are then provided for the PCEF 30. The determined PCC rules generally include detecting rules of service data streams, whether performing a gating or not, the quality of service (QoS) of the service data streams, and charging rules based on the streams.

The SPR 20 is adapted to provide user subscription information stored therein for the PCRF 10.

The PCEF 30 is adapted to perform corresponding detection of service data streams, implement related QoS policies to ensure the QoS of the service data streams, and carry out charging based on the streams according to the PCC rules provided by the PCRF 10.

The CSCF 40 is adapted to realize functions of user registration, call session control, and the like. The CSCF 40 includes a proxy-call session control function (P-CSCF) 50 that serves as an SIP proxy server on an SIP layer, and an emergency-call session control function (E-CSCF) (not shown in the Figure) adapted to handle call session function of an emergency service.

The HSS 60 is adapted to perform centralized management on the user subscription data.

The SLF 70 is adapted to locate a specific HSS where the information of a certain subscriber is saved.

The emergency communication service refers to a type of service that a communication network provides emergency aids for a user when the individual/public health and safety as well as life and property of the user are threatened. For example, the user dials the number of 110 or 119, which is a typical case of seeking for emergency help via the communication network. Generally, in order to provide communication services at a high emergency service level for the emergency service, the communication network needs to route the service to the most appropriate public safety access point (PSAP) according to the location information of a calling party and the type of the emergency service, and then the PSAP routes the service to the most appropriate emergency call center (ECC) for processing, and the ECC rapidly provides help for the user.

Currently, a processing manner of an emergency service for a user under IMS network architecture has been proposed in this field, which includes the following steps.

After accessing a network, a terminal establishes an IP access network (IP-AN) bearer with a network side, and obtains an IP address and then is capable of performing a discovery process of a P-CSCF. After obtaining an entry address of the P-CSCF, the terminal initiates an IMS emergency service registration or an emergency service session request to the P-CSCF in the IMS network according to the obtained address of the P-CSCF. The P-CSCF receives the emergency service registration or emergency service session request from the terminal, and identifies that the service requested by the terminal is an emergency service according to an emergency service indication carried in the request, and then forwards the request to the E-CSCF for processing. Next, the E-CSCF sends the request to the PSAP, and the PSAP further routes the request to the most appropriate ECC or a Public Safety Answering Center (PSAC).

If the terminal that initiates the emergency service needs to be located in the above process, the P-CSCF or E-CSCF triggers a location based services server (LBS server) and requests the LBS server to locate the terminal. The LBS server locates the terminal, and returns location information of the terminal to the P-CSCF or E-CSCF (if the location information is returned to the P-CSCF, the P-CSCF still needs to report the location information to the E-CSCF). Afterwards, the E-CSCF sends the location information and the emergency service request to the ECC or the PSAC, and then the ECC or the PSAC provides help for the terminal according to the location information of the terminal.

The inventor(s) of the disclosure finds that, during the processing of an emergency communication service in the prior art, it fails to provide a solution about how to access a radio network system in an emergency and initiate an emergency service call when the user encounters an emergency situation in the radio network system, especially in a worldwide interoperability for microwave access (WiMAX) network, so as to get emergency aids based on the radio network system.

### SUMMARY OF THE INVENTION

Accordingly, the disclosure is directed to a method for realizing an emergency communication service, so as to provide an emergency communication service processing capability for a user based on a radio network system.

The disclosure is also directed to a system and an apparatus for realizing an emergency communication service.

An embodiment of the disclosure provides a method for realizing an emergency communication service. The method includes:

receiving, by a radio network side, a message carrying an emergency service indication sent by a user terminal;

establishing a bearer link for bearing emergency service signaling and emergency service data for the user terminal;

receiving, by the network side, an address obtaining request sent by the user terminal based on the bearer link for bearing the emergency service signaling;

delivering to the user terminal a local network communication address allocated for the user terminal and an access point address to an apparatus providing a local network emergency service based on the bearer link for bearing the emergency service signaling; and

communicating, by the apparatus providing a local network emergency service on the network side, with the user terminal based on the established bearer link.

An embodiment of the disclosure further provides a method for realizing an emergency communication service. The method includes:

sending a message carrying an emergency service indication to a radio network side;

requesting the radio network side for address information based on a bearer link for bearing emergency service signaling established by the radio network side according to the message carrying the emergency service indication; and

initiating an emergency call to an apparatus providing a local network emergency service according to an access point address to the apparatus providing a local network emergency service delivered by the radio network side and based on a communication address allocated by the radio network side and the established bearer link for bearing the emergency service signaling and emergency service data.

An embodiment of the disclosure provides a user terminal. The user terminal includes:

a unit adapted to send a message carrying an emergency service indication to a radio network side;

a unit adapted to request the radio network side for address information based on a bearer link for bearing emergency service signaling established by the radio network side; and

a unit adapted to initiate an emergency call to an apparatus providing a local network emergency service according to an access point address to the apparatus providing a local network emergency service delivered by the radio network side and based on a communication address allocated by the radio network side and the established bearer link for bearing the emergency service signaling and emergency service data.

An embodiment of the disclosure provides a system for realizing an emergency communication service. The system includes:

a unit adapted to establish a bearer link for bearing emergency service signaling and emergency service data for a user terminal after receiving a message carrying an emergency service indication sent by the user terminal;

a unit adapted to allocate a local network communication address for the user terminal after receiving an address request sent by the user terminal; and

a unit adapted to deliver to the user terminal the local network communication address allocated for the user terminal and an access point address to an apparatus providing a local network emergency service based on the established bearer link for bearing the emergency service signaling.

An embodiment of the disclosure provides an access service network gateway (ASN-GW). The ASN-GW includes:

a unit adapted to establish a bearer link for bearing emergency service signaling and emergency service data for a user terminal after a radio network receives a message carrying an emergency service indication sent by the user terminal;

a unit adapted to obtain a local network communication address allocated for the user terminal after receiving an address request sent by the user terminal; and

a unit adapted to deliver to the user terminal the obtained local network communication address and an access point address to an apparatus providing a local network emergency service based on the established bearer link for bearing the emergency service signaling.

Through the embodiments of the disclosure, in a radio network system, a user terminal can initiate an emergency call based on the radio network in case of an emergency despite whether the user terminal has accessed the network and become a valid user or not, so as to establish communication with an apparatus capable of providing an emergency service in the local network and thus get emergency aids.

### BRIEF DESCRIPTION OF THE DRAWINGS

To make the specific implementations and corresponding beneficial effects achieved by the technical solutions of the disclosure more comprehensible, the embodiments of the disclosure are described in detailed below for illustration only by referring to the accompanying drawings among which:

FIG. 1 is a block diagram of a basic structure of an existing IMS;

FIG. 2 is an architectural view of an existing WiMAX network system;

FIG. 3 is a schematic view of an existing QoS architecture based on WiMAX;

FIG. 4 is a schematic flow chart of a method for realizing an emergency communication service according to an embodiment of the disclosure;

FIGS. 5A and 5B are a processing flow chart of a first embodiment of the disclosure;

FIGS. 6A and 6B are a processing flow chart of a second embodiment of the disclosure;

FIG. 7 is a processing flow chart of a third embodiment of the disclosure;

FIG. 8 is a processing flow chart of a fourth embodiment of the disclosure; and

FIG. 9 is a block diagram of a structure of a WiMAX network system applying the method of the disclosure.

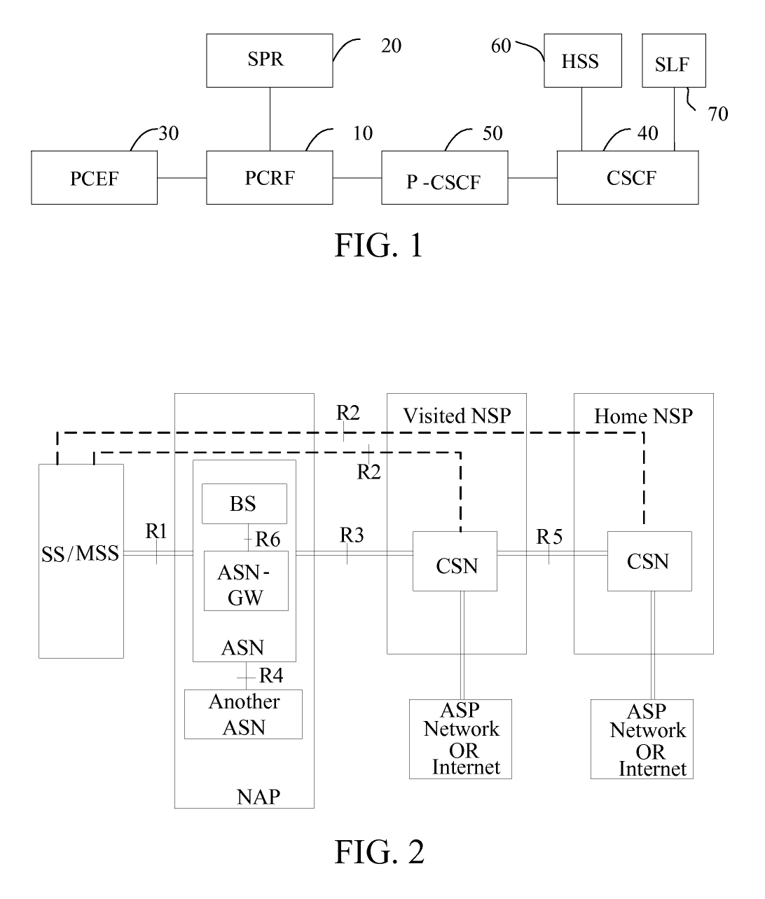

### DETAILED DESCRIPTION OF THE EMBODIMENTS

Through the embodiments of the disclosure, in a radio network system, a user terminal can access the network to get emergency aids in case of an emergency. The radio network system includes networks based on the WiMAX protocol, Global System for Mobile Communication (GSM), Code Division Multiple Access (CDMA) communication system and its evolution system of Ultra Mobile Broadband (UMB), Wide Code Division Multiple Access (W-CDMA) communication system in the future and its evolution system of Long Term Evolution (LTE), and the like.

The WiMAX network system is taken as an example for illustration below, and the specific implementations of other radio network systems are similar to that of the WiMAX network system.

FIG. 2 is a schematic architectural view of an existing WiMAX network system.

WiMAX is a newly emerging wireless communication technology capable of providing Internet-oriented high speed wireless connections. The WiMAX network system mainly includes a mobile station (MS), an access service network (ASN), and a connect service network (CSN).

The MS is terminal equipment provided for a user to access the WiMAX network.

The ASN is a network function set adapted to provide radio access services for WiMAX terminals. The ASN specifically includes two network elements (NEs), namely, a BS and an ASN-GW. The BS is mainly adapted to provide Layer 2 (L2) connection for the BS and the MS, radio resource management, and the like. The ASN-GW is mainly adapted to provide client functions for authentication, authorization, and accounting of the MS, and provide Layer 3 (L3) information relay function (for example, IP address allocation) for the MS, intra-ASN handover function, and the like.

The CSN is adapted to provide IP connection services for the WiMAX terminals. The CSN mainly provides IP address allocation, Internet access, AAA proxy or server, user-based authorization control, and other functions for the MS.

The above three logic entities that constitute the WiMAX network system communicate with one another via interfaces R1 to R6.

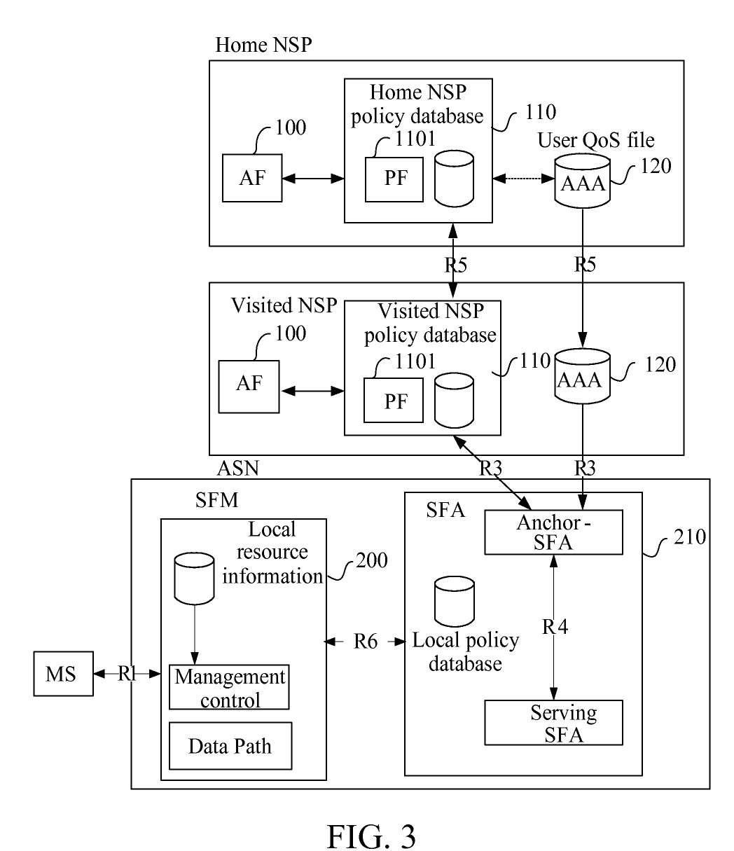

FIG. 3 is a schematic view of an existing QoS architecture based on WiMAX. A network service provider (NSP) includes an application function (AF) 100, a policy database 110, and an AAA server 120. The policy database 110 further includes a policy function (PF) 1101 adapted to provide policies for a user service flow. The AF 100 is adapted to inform the PF 1101 to initiatively provide policies for the user service flow. The ASN includes: a service flow management (SFM) 200, adapted to establish a corresponding service flow for the user and allocate radio resources for the established service flow; and a service flow authorization (SFA) 210, adapted to authorize a corresponding service flow of the user.

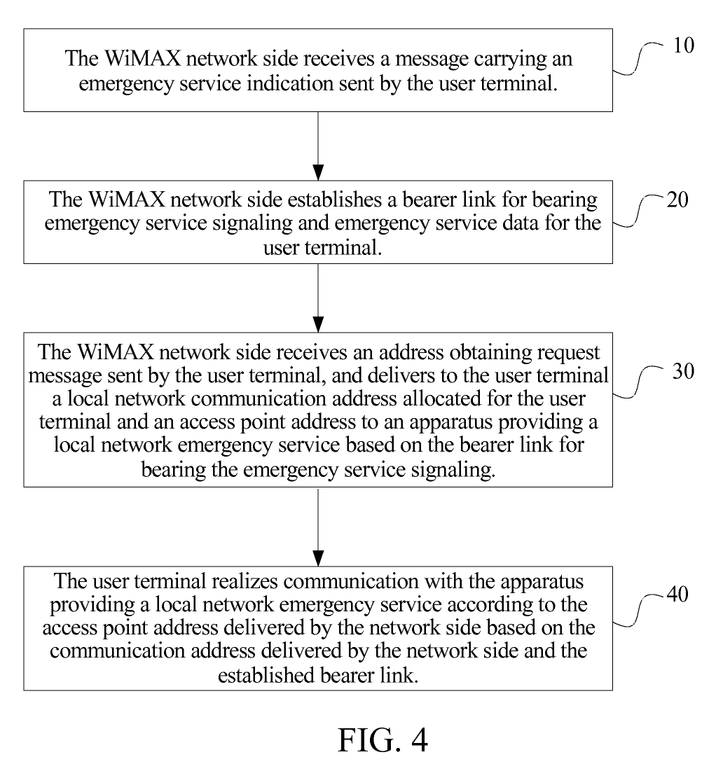

FIG. 4 shows a process of establishing an emergency service when a user terminal in a WiMAX network system needs to make an emergency call in case of an emergency, which mainly includes the following steps. The user terminal sends a message carrying an emergency service indication (for example, a subscriber basic capability (SBC) message) to a WiMAX network side when encountering an emergency situation, and the WiMAX network side receives the message carrying the emergency service indication sent by the user terminal (step 10). The WiMAX network side establishes a bearer link for bearing emergency service signaling and emergency service data for the user terminal (step 20). The WiMAX network side receives an address obtaining request sent by the user terminal based on the bearer link for bearing the emergency service signaling, and delivers to the user terminal a local network communication address allocated for the user terminal and an access point address to an apparatus providing a local network emergency service based on the bearer link for bearing the emergency service signaling (step 30). The user terminal realizes communication with the apparatus providing a local network emergency service according to the access point address delivered by the network side based on the communication address delivered by the network side and the established bearer link (step 40), so as to get emergency service aids.

The implementation of a method for realizing an emergency communication service according to an embodiment of the disclosure is described below. When a user terminal in a WiMAX network system encounters an emergency situation, the user terminal initiates the following network access process if the user terminal has not accessed the network yet.

1. The user terminal initially accesses the network based on the IEEE802.16e protocol, and performs a ranging process and an SBC negotiation process with the BS in the ASN. The user terminal may carry an emergency service indication in a ranging message or an SBC message sent to a network side, so as to indicate that the user terminal needs to establish an air-interface connection for an emergency service. In addition, the user terminal may also inform the network side about whether to perform an equipment authentication or not during the SBC negotiation process. When the user terminal carries a no-authentication indication in the SBC message, it indicates that the network side does not need to perform an equipment authentication on the user terminal, and the network side agrees not to perform the equipment authentication on the terminal based on the emergency service indication.

2. Authentication and authorization are performed on the user terminal and/or user that initiate the emergency service indication, which is an optional process. When this process is omitted, the implementation directly skips to the subsequent process 3 after finishing the above process 1.

This process can be implemented in the following two modes.

Mode 1: The AAA server in the CSN performs authentication and authorization on the user terminal and/or user. An authenticator in the ASN sends an Extensible Authentication Protocol-Identity (EAP-Identity) request to the user terminal, so as to trigger an EAP authentication process. If the equipment authentication on the terminal is to be performed before the user authentication, the user terminal needs to carry a network access identity (NAI) of the terminal equipment, for example, a media access control (MAC) address of the user terminal to perform the equipment authentication, and the user authentication is performed after the terminal passes the equipment authentication.

To ensure that the emergency service required by the user is provided timely, regardless of the equipment authentication result of the terminal (whether being successful or not), the user terminal receives the EAP-Identity request delivered by the network side, and may carry the emergency service indication in the following statement to be sent to the authenticator in the ASN:

([RoutingRealm1!RoutingRealm2! . . . !] {AuthMode} (WiMAX Option)pseudoIdentity@realm

In the above statement, the WiMAX Option field carries the emergency service indication, which indicates to the authenticator that it is an emergency service access request. The Routing Realm and Realm fields are optional in the above statement. If the user terminal has performed network discovery and selection, the Routing Realm and Realm fields are added to the above statement, so as to request the AAA server for a routing destination address. If the user terminal does not perform the network discovery and selection, the Routing Realm and Realm fields do not need to be added to the above statement.

The authenticator receives the statement message that carries the emergency service indication sent by the user terminal, and encapsulates the message in an Access-Request to be forwarded to a default AAA (this AAA may be pre-configured on the authenticator and exclusively adapted to process emergency services; and generally may be an AAA in a visited CSN or an AAA in an ASN) for performing the access authentication. After receiving the Access-Request that carries the emergency service indication sent by the authenticator, the AAA server may not perform authentication (an EAP challenging process) on the user, but directly perform emergency service authorization on the user.

Moreover, an air-interface encryption may be selectively performed on messages subsequently interacted between the user terminal and the BS. In this case, a random number generator (RNG) in the AAA server is required to generate a master session key (MSK) and an extensible master session key (EMSK) for the user terminal, and then the AAA server carries the generated MSK and a key (i.e. PMN-HA-Key) between a PMIP client and a home agent (HA) obtained based on the EMSK in an Access-Accept message to be sent to the authenticator. The authenticator generates a pairwise master key (PMK) according to the MSK, and generates an authorization key (AK) adapted to encrypt data transmitted via the air interface according to the PMK. Then, the authenticator in the ASN sends the generated AK to the BS, and then the BS carries the AK in a privacy key management version2 (PKMv2) message to be sent to the user terminal. Afterwards, the user terminal and the BS perform the message integrity protection on the data transmitted via the air interface based on the AK. Certainly, the authenticator or the BS in the ASN may directly perform the access authentication on the user terminal that accesses in case of an emergency, and directly generate the AK, air-interface traffic encryption key (TEK), and other application keys (for example, MIP key) that are adapted to protect data transmitted via the air interface.

Definitely, the security protection may not be performed on the air-interface data transmission for the emergency service.

If the user that accesses for the emergency service needs to be selectively charged, the AAA server performs authentication on the user, and then delivers a hotline active indication to the ASN-GW via the Access-Accept message. Then, the ASN-GW provides the emergency service in a mode of providing a hotline service, and provides an emergency service related charging record to the AAA server.

Mode 2: The authenticator in the ASN performs authentication and authorization on the user terminal and/or user. If the air-interface transmission of the emergency service data needs to be protected, the authenticator directly generates an AK adapted to protect an air-interface message, AK=RAND (random number), and the BS generates a TEK adapted to encrypt the air-interface message, TEK=RAND (random number). The BS then sends the TEK to the user terminal, so that an encryption protection on the data subsequently interacted between the BS and the user terminal can be realized based on the TEK.

If the authenticator or the AAA server in the ASN performs the authentication on the user and/or user terminal, when an address request sent by the user is received subsequently, the ASN-GW directly allocates an IP address of the network to the user, and when an IP data packet needs to be forwarded, the ASN-GW performs network address translation (NAT).

If the authentication and authorization are not performed on the user terminal that initiates an emergency service access, the authenticator in the ASN directly sends a NetEntry MS State Change Directive message to the BS, so as to inform the BS that the user successfully accesses the network.

3. The network side establishes a pre-provisioned flow for the user terminal that initiates the emergency service access, which serves as a bearer link for bearing emergency service signaling of the user. The network side may carry an emergency service identifier (ID) in a resource reservation message and an air-interface dynamic service addition (DSA) message, so as to realize the establishment of the pre-provisioned flow. A data stream classifier in the established pre-provisioned flow needs to be restricted to only receiving data from an emergency call center (ECC), and cannot bear non-emergency service data. For example, a destination address of an uplink classifier and a source address of a downlink classifier in the pre-provisioned flow are set to an address of the ECC, so that data packets passing through the classifiers are restricted to data sent to the ECC or data from the ECC, and the other data packets are directly discarded by a data path function (DPF) on the ASN-GW.

In addition, in the above process, several high bits in an allocated service flow identifier (SFID) can be employed to identify the emergency service, so that the network side is enabled to perform corresponding emergency access processing after identifying the SFID in the several high bits.

4. The user terminal obtains information of a local network communication address and an access point address to an apparatus providing a local network emergency service based on the established pre-provisioned flow for bearing an emergency service signaling message. The local network communication address can be obtained in the following two modes.

Mode 1: The user terminal initiates a dynamic host configuration protocol (DHCP) message to a DHCP proxy or DHCP relay on the ASN-GW through the established pre-provisioned flow, so as to obtain an IP address. In this case, the local network communication address allocated by the network side for the user terminal is a simple IP address, which may be a public IP address or a private IP address.

Mode 2: The user terminal directly initiates an MIP registration through the established pre-provisioned flow or through a PMIP client on the ASN-GW. In this case, the local network communication address allocated by the network side for the user terminal is a public IP address, which remains unchanged after the user terminal performs an inter-ASN handover.

As for the PMIP registration, the user terminal initiates the DHCP process through the established pre-provisioned flow to obtain a home address (HoA). As for a user terminal carrying an emergency service NAI, the PMIP client in the ASN-GW, as an agent of the user terminal, initiates the MIP registration. Specifically, the PMIP client requests the authenticator for the PMN-HA-Key, so as to perform integrity protection on an MIP registration message based on a generated extension authentication header (AH) of the MIP registration message. Alternatively, when the PMIP client performs an MIP registration as an agent of a user with an emergency service, the PMIP client does not carry an extension AH in the MIP registration message, i.e. does not perform integrity protection on the MIP registration message.

In addition, if the network side provides an MIP service for the user terminal that accesses the network in case of an emergency, an AAA server capable of performing emergency authentication allocates an HA in a local visited network for the user terminal. Furthermore, the AAA server capable of performing emergency authentication first performs authentication and authorization on the user, and then carries an HA address in an Access-Accept message to be sent to the ASN-GW. After the user terminal successfully accesses the network, the PMIP client on the network side, as an agent of the user terminal, initiates an MIP registration, or the user terminal directly initiates an MIP registration.

After obtaining the IP address of the user terminal, the user terminal further needs to obtain information of an access point address to an apparatus providing an emergency service.

Generally, when a mobile user terminal uses the MIP mode in a roaming area, the HA thereof may be allocated at home or in the visited place. However, as for an emergency call service, when the user initiates an emergency service in the roaming area, the HA may be allocated locally. Besides, as for an emergency call service, the MIP mode may not be used, but only a simple IP mode is used for emergency service communication.

The network side sets restrictions in the classifiers that the local network communication address allocated for the user terminal can only be applied for emergency service communication.

5. If the pre-provisioned flow established in the above process 3 is further adapted to bear emergency service data, the user terminal realizes communication with the apparatus providing a local network emergency service through the pre-provisioned flow according to the access point address delivered by the network side and based on the communication address delivered by the network side, so as to obtain the emergency service.

If the pre-provisioned flow established in the above process 3 is not adapted to bear the emergency service data, the network side needs to establish a bearer link for bearing the emergency service data for the user terminal, i.e. to establish a service flow for bearing the emergency service data. The service flow for bearing the emergency service data is established in the following process.

When the user terminal obtains an IP address, the user terminal or the SFA on the network side establishes an IP access bearer for bearing emergency service data. Particularly, after receiving an IP access bearer establishment request, the SFA requests a PCRF for PCC rules or directly receives PCC rules from the PCRF. The request carries an emergency service ID, which may be explicitly carried or implicitly carried by an NAI. The PCRF generates the PCC rules according to prescribed emergency service policies and charging policies (generally set no-charging), and delivers the generated PCC rules to the SFA. The SFA performs QoS authorization and service flow establishment according to the QoS in the PCC rules, so as to finish the establishment of the service flow for bearing the emergency service data. Certainly, after receiving the IP access bearer establishment request sent by the user terminal, the SFA may directly establish the service flow for bearing the emergency service data for the user terminal.

In order to bear the emergency service data by the established service flow, the SFA needs to send the received data stream detection information (IP quintuple, i.e. source address, destination address, source port number, destination port number, and protocol type information) to a DPF for performing data stream detection, i.e. detecting whether the received data stream belongs to the emergency service data or not. The data stream is respectively detected by an uplink classifier and a downlink classifier. Specifically, a destination address of the uplink classifier and a source address of the downlink classifier are set to an address of the ECC, so that data packets passing through the classifiers are restricted to data sent to the ECC or data from the ECC, and the other data packets are directly discarded by the DPF.

In this way, the user terminal realizes communication with the apparatus providing a local network emergency service through the established pre-provisioned flow (or the service flow) according to the access point address information delivered by the network side and based on the communication address delivered by the network side, so as to obtain the emergency service.

In the WiMAX network, an emergency service may be provided by the ASN or the CSN in the WiMAX network. A mode of providing the emergency service by the ASN and a mode of providing the emergency service by the CSN are respectively described as follows.

1. When the local network communication address obtained by the user terminal in the above process is a simple IP address, the emergency service is provided by the ASN.

The providing of the emergency service by the ASN means that the access authentication and authorization of the user, the emergency service information, the establishment of the pre-provisioned flow or the service flow, and other operations are all controlled by the ASN entity. The ASN provides the emergency service in the following two modes.

Mode 1: In one case, an emergency service communication is performed based on an IMS. At this time, the ASN-GW is directly connected to a particular P-CSCF, and the P-CSCF triggers the establishment of the bearer for the emergency service. The P-CSCF needs to include a part of a policy and charging decision function, and needs to support WiMAX interface messages. At this time, the access point address to the apparatus providing a local network emergency service provided by the network side for the user terminal is P-CSCF address information in the local network. In the other case, an emergency service communication is performed based on a high-level protocol other than the IMS. This process is similar to the emergency service communication based on the IMS. However, in this case, the access point address provided by the network side for the user terminal is address information of a PSAP in the local network.

Mode 2: If the ASN-GW can be directly connected to the PSAP in the WiMAX network, the ASN-GW locates and finds a corresponding PSAP after receiving an emergency network access indication from the user, and then informs the user terminal of the obtained PSAP as an access point address. Therefore, the user terminal establishes communication with the PSAP in the local network based on the established pre-provisioned flow or service flow, so as to establish an emergency service communication. Furthermore, when the user initiates an emergency call, the network side may be informed via a MAC layer signaling, for example, the network side is informed about an emergency access via a DSA message carrying an emergency service ID. The BS receives the DSA message, and then initiates a resource reservation message to the SFA. Then, the SFA triggers an interaction between the ASN-GW and the PSAP after identifying the emergency service ID, and informs the user terminal of the PSAP as an access point address.

2. When the local network communication address obtained by the user terminal in the above process is an MIP address or a public IP address obtained through the PMIP mode, the emergency service is provided by the CSN.

Mode 1: An emergency service communication is performed based on an IMS. The user terminal initiates an IMS emergency call by using a public anonymous IMS ID and an emergency service indication. If the network side needs to locate the user terminal that initiates the emergency service call, a P-CSCF or an E-CSCF in the CSN triggers an LBS server to locate the user terminal. The LBS server locates the user terminal, and then returns location information of the user terminal to the P-CSCF or the E-CSCF (if the location information is returned to the P-CSCF, the P-CSCF still needs to report the location information to the E-CSCF). Afterwards, the E-CSCF sends the location information and an emergency service request to the ECC or the PSAC, and then the ECC or the PSAC provides help for the user terminal according to the location information of the user terminal.

In this case, the network side informs the user terminal of P-CSCF address information as an access point address. The P-CSCF address information may be delivered by the AAA server to the ASN-GW during the network access process of the user terminal, and the AAA server allocates a P-CSCF in a visited network for the user terminal carrying an emergency service indication or directly pre-configures a P-CSCF address in the local network on the ASN-GW. In this way, the user terminal obtains the P-CSCF address information in the local network through a DHCP process after the user terminal successfully accesses the network. Specifically, the user terminal sends a DHCP message to the ASN-GW, and the ASN-GW carries the P-CSCF address information in a DHCP response message to be sent to the user terminal.

Mode 2: An emergency service communication is not performed based on an IMS. The user terminal establishes an emergency communication with the PSAP through other application layer protocols. In this case, the process of establishing an emergency call by the user terminal is similar to the process of establishing an emergency call based on the IMS, and the difference there-between is that, the emergency call is initiated by other application layer protocols. At this time, the PSAP address information is taken as an access point address to the apparatus providing an emergency service in the local network and is provided to the user terminal.

During the emergency service communication between the user terminal encountering an emergency situation and the apparatus providing an emergency service communication in the local network, when an inter-area handover occurs to the user terminal, the corresponding emergency service information (for example, the emergency service indication) needs to be transferred from a serving BS to a target BS while being carried in terminal information (MS Info TLV); and when the user terminal enters an idle mode, the corresponding emergency service information (for example, the emergency service indication) needs to be transferred from the serving BS to an anchor PC while being carried in the MS Info TLV.

In view of the above descriptions of the method provided in the embodiment of the disclosure, several embodiments are given below to demonstrate different implementations of the disclosure.

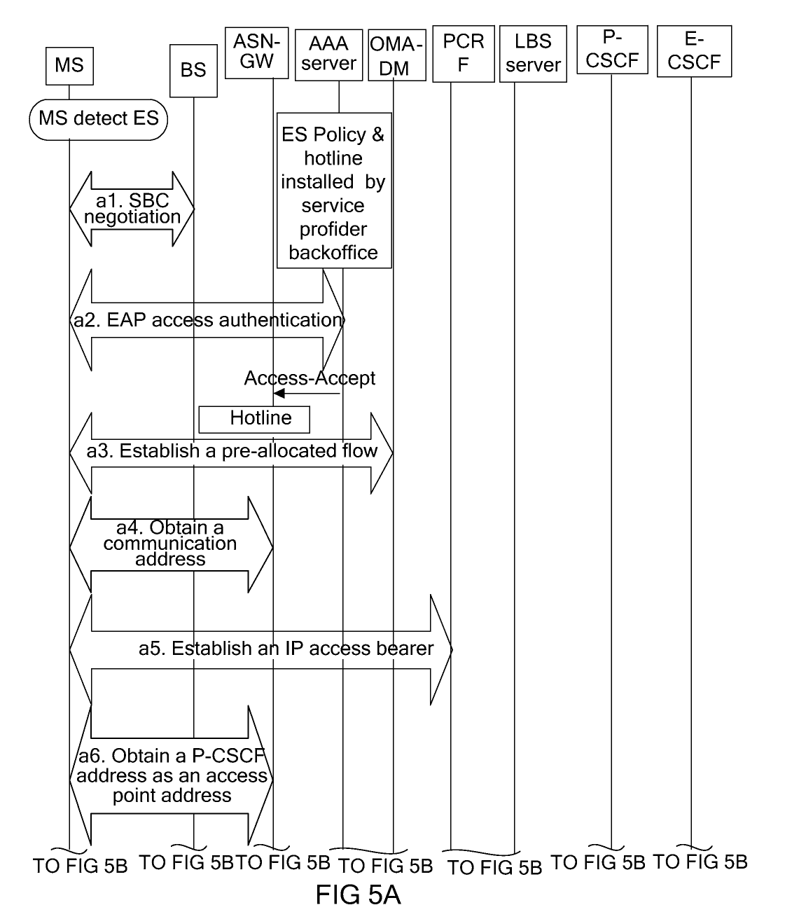

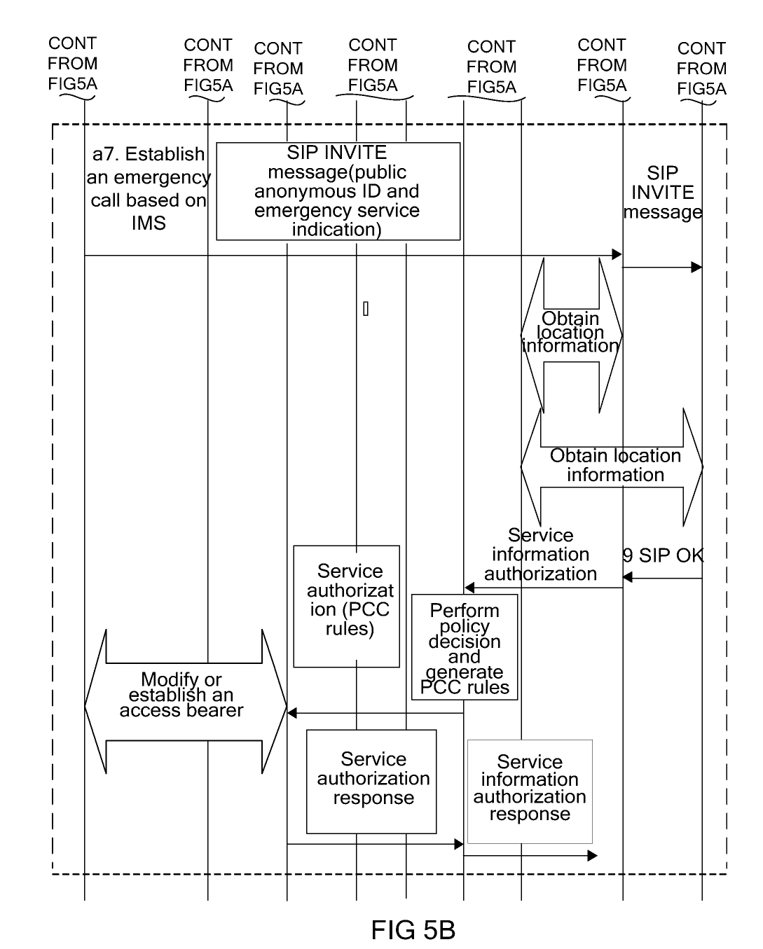

FIGS. 5A and 5B are a processing flow chart of a first embodiment of the disclosure. In a WiMAX network system, when a user that has not accessed a network encounters an emergency situation, the processing flows from accessing the network to establishing an emergency service are described as follows.

In step a1, when encountering an emergency situation, the user terminal performs a ranging process and an SBC negotiation process with a BS in time. The user terminal may carry an emergency service indication in a ranging message or an SBC message, which informs the network side through the BS that the user terminal needs to establish an air-interface connection for bearing an emergency service.

In step a2, during the SBC negotiation process, it may be negotiated whether to perform an authentication on the user and/or user terminal or not, which is optional.

If the negotiation result shows that the authentication needs to be performed on the user and/or user terminal, an authenticator in an ASN-GW may send an EAP-Identity request to the user terminal, so as to trigger a user authentication process. The user terminal carries an NAI and the emergency service indication in an authentication request. An illustrative format of the authentication request is shown as follows:

NAI([RoutingRealm1!RoutingRealm2! . . . !] {AuthMode} (WiMAXOption)pseudoIdentity@realm

The WiMAX Option field represents whether it is an emergency service or not, and the pseudoIdentity field represents an emergency service ID.

If the authentication needs to be performed on the user terminal that initiates the emergency service indication, the user terminal carries a terminal ID (for example, an MAC address of the terminal) in the EAP-Identity message to be sent to the authenticator, so as to inform the authenticator that the equipment authentication request is made based on an emergency service access. The authentication process on the user and/or user terminal may be implemented by the authenticator in the ASN-GW or by an AAA server in a CSN.

In the following example, the AAA server performs the authentication on the user and/or user terminal. The authenticator in the ASN-GW encapsulates the EAP-Identity request sent by the user terminal in a Radius message to be sent to a local AAA server. After receiving the request carrying the emergency service indication, the AAA server may not perform an authentication (EAP challenging process) on the user, but directly perform authorization on the user terminal, so as to allow the user terminal to access the emergency service. The AAA server delivers an emergency service type, service priority, QoS, and charging rules (no charging may be applied for the emergency service) to a PCRF.

If air-interface resources between the user terminals that initiate an emergency service request and the BS in the ASN further need to be protected, the AAA server further employs an RNG to generate an MSK and an EMSK for the user terminal. Then, the AAA server carries the MSK and a PMN-HA-Key generated based on the EMSK (the PMN-HA-Key is a key adapted to ensure the integrity of an MIP registration message between a PMIP client and an HA) in an Access-Accept message to be sent to the authenticator. Then, the authenticator generates a PMK according to the MSK sent by the AAA server, then generates an AK according to the generated PMK, and further generates an air-interface key according to the AK. As for the user terminal that initiates an emergency service access, the security protection may not be performed on the air-interface resources. If the air-interface connection between the user terminal that initiates the emergency service access and the BS needs to be protected, after obtaining the AK, the BS carries the AK in a PKM-Response message to be sent to the user terminal, so that the user terminal performs encryption protection on the transmitted wireless data based on the AK.

In step a3, the BS identifies that the SBC message sent by the user terminal carries the emergency service indication, and sends an emergency access request to the ASN-GW. Upon receiving the request, the ASN-GW directly allows the user terminal to access and subsequently responds with an access success message to the user terminal; or responds with an access success message to the user terminal after performing the authentication as mentioned in step a2. After the user terminal successfully accesses the network, the ASN-GW establishes a pre-provisioned flow for bearing an emergency service signaling message interacted between the user terminal and the network side.

In step a4, the user terminal obtains a local network communication address based on the established pre-provisioned flow in the following two modes.

Mode 1: After the user terminal passes the authentication, the AAA server delivers an IP address allocated for the user terminal to the ASN-GW. Then, the user terminal initiates a DHCP message to a DHCP proxy or a DHCP relay on the ASN-GW, so as to obtain the IP address of the user terminal in the local network (in this case, the obtained address is a simple IP address).

Mode 2: When the user terminal that initiates the emergency service indication sends a DHCP request to the ASN-GW, the PMIP client on the ASN-GW, as an agent of the user terminal, initiates an MIP registration, and then the ASN-GW returns a DHCP response message and a global IP address to the user terminal.

As for the user terminal that initiates the emergency service indication, when the user terminal initiates an MIP registration to an FA, the FA performs the MIP registration on the HA, the HA sends an MIP registration response message and a home IP address to the FA after the registration is completed, and then the FA sends the MIP registration response message and the home IP address to the user terminal.

In step a5, if the pre-provisioned flow established in step a3 can be directly adapted to bear emergency service data, this step may be omitted. If a new IP access bearer link is required to bear emergency service data interacted between the user terminal and the network side, after the user terminal obtains an IP address, the user terminal or the SFA on the network side initiates the establishment of an IP access bearer link. After receiving an IP access bearer establishment request, the SFA requests a PCRF for PCC rules. The PCRF generates the PCC rules according to prescribed emergency service policies and charging policies (generally being set as no-charging), and delivers the generated PCC rules to the SFA. The SFA performs the QoS authorization and service flow establishment according to QoS carried in the PCC rules, so as to establish a service flow for bearing the emergency service data, and further sends service flow detection information to a DPF. The DPF detects data streams on the service flow bearer link according to the service flow detection information, and it is restricted that only the emergency service data can pass there through, and the other data are directly discarded by the DPF.

In step a6, a P-CSCF address as the access point address to an apparatus providing an emergency service in the local network is delivered by the AAA server to the ASN-GW after the authentication is performed on the user terminal, or is pre-configured on the ASN-GW. Then, the user terminal may request the ASN-GW for the P-CSCF address as the access point address through a DHCP process.

In step a7, the user terminal initiates an emergency service call through the established pre-provisioned flow (or service flow) according to the obtained P-CSCF address as the access point address and based on the obtained local network communication address, and establishes communication with the PSAP, so as to obtain emergency service aids. The illustrative implementation is as follows.

The user terminal initiates an IMS emergency call by using a public anonymous IMS ID and an emergency service indication. If the network side needs to locate the user terminal that initiates the emergency service call, a P-CSCF or an E-CSCF in the CSN triggers an LBS server to locate the user terminal. The LBS server locates the user terminal, and then returns location information of the user terminal to the P-CSCF or E-CSCF (if the location information is returned to the P-CSCF, the P-CSCF still needs to report the location information to the E-CSCF). Afterwards, the E-CSCF sends the location information and an emergency service request to the ECC or the PSAC, and then the ECC or the PSAC provides help for the user terminal according to the location information of the user terminal.

In step a7, after the IMS emergency service call is established, the P-CSCF sends the emergency service information to the PCRF, so as to trigger the PCRF to perform the policy decision. If the PCRF determines that the user's resources are insufficient to support the current emergency service call according to the current resource situation of the user, some communication services currently performed by the user terminal may be selectively terminated to ensure the priority and the QoS of the emergency service. After performing the policy decision, the PCRF delivers the PCC rules of the emergency service to a PCEF (including SFA, Anchor DPF, and Accounting Client/Agent) in the ASN-GW through a PCEF proxy, and the PCEF performs corresponding operations on the emergency service call initiated by the user terminal according to the PCC rules delivered by the PCRF.

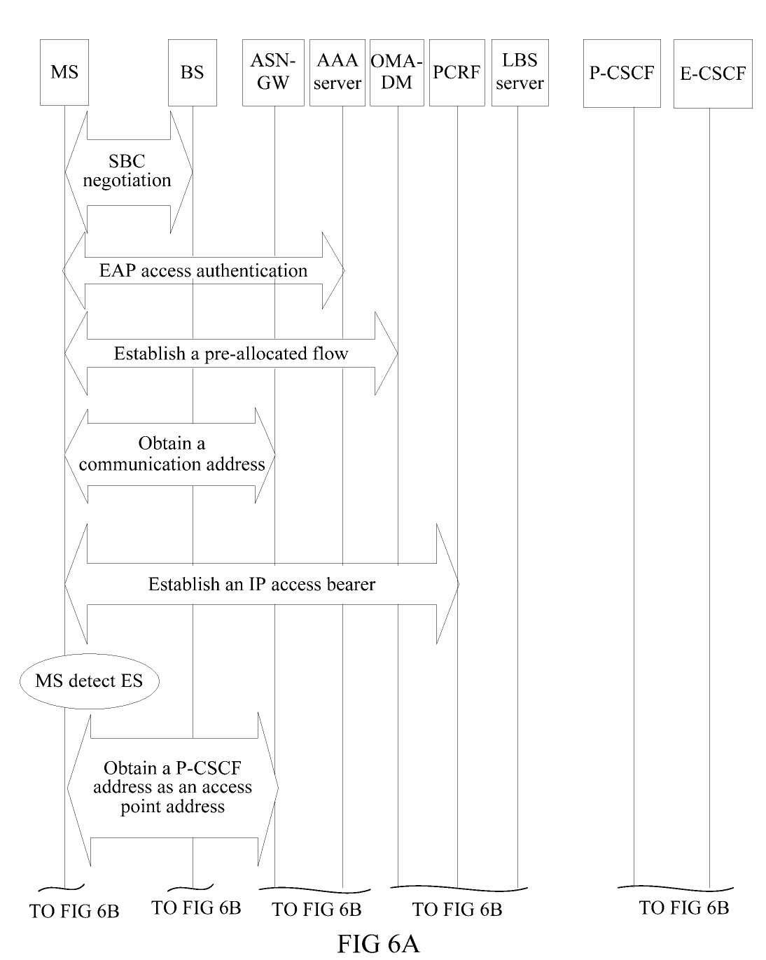

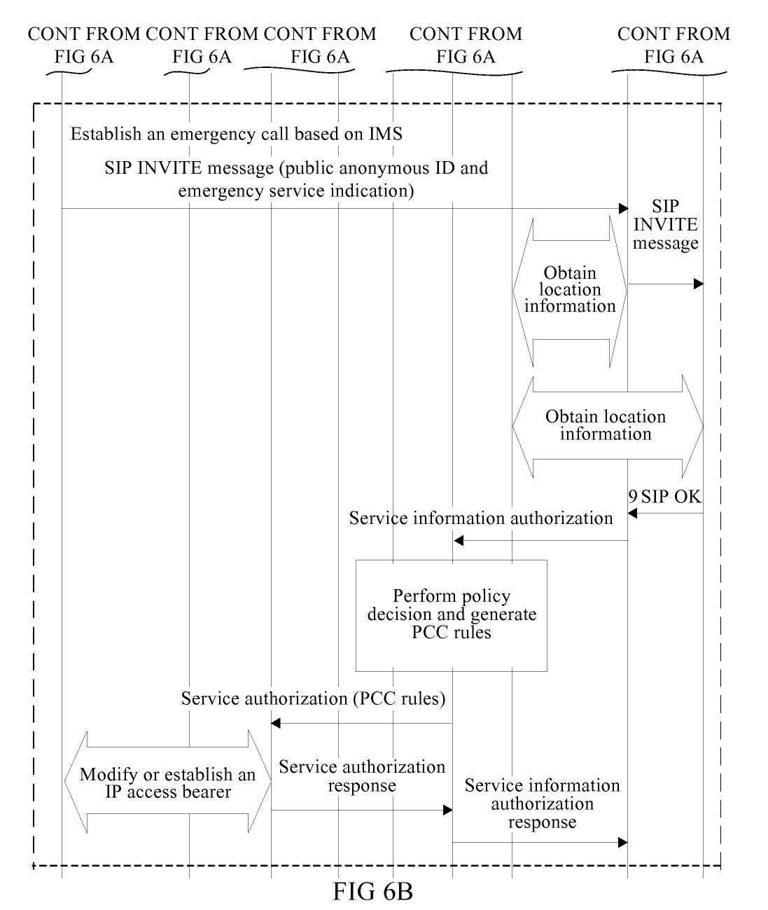

The above embodiment describes the processes when the user encounters an emergency service situation before accessing the network, in which the user terminal may be a WiMAX network valid terminal (i.e. the user terminal has subscribed to the WiMAX network and its account is valid) or a WiMAX network invalid terminal (i.e. the user terminal does not subscribe to the WiMAX network, or its account is defaulting or out of service). Certainly, if the user has completed the network access registration and become a valid user before encountering an emergency situation, the user terminal can directly obtain the access point address in case of an emergency, initiate an emergency service call through the established pre-provisioned flow (or service flow) based on the obtained access point address information, and establish communication with the ECC, thereby obtaining emergency service aids. The illustrative implementation may be obtained with reference to FIGS. 6A and 6B, which are a processing flow chart of a second embodiment of the disclosure.

During the implementation of the above first and second embodiments, the network side may further pre-configure emergency service policies and hotline support in the AAA server. After the user terminal uses the emergency service NAI to complete the EAP access authentication, the AAA server indicates the authorization information (for example, an IP address, MSK, and emergency service policies) and hotline policies to the ASN-GW, and then the charging proxy in the ASN-GW provides hotline support for the user terminal, so as to ensure the user to obtain the emergency service with no charging account or in case of defaulting. An open mobile alliance for device management (OMA-DM) server in the network may configure security information (including user credentials or key information) for the user terminal through an OMA protocol. The user terminal generates corresponding key information (for example, MSK/EMSK) according to the configured user credentials, or directly uses the key generated by the network side to protect the confidentiality of the data transmitted via the air interface.

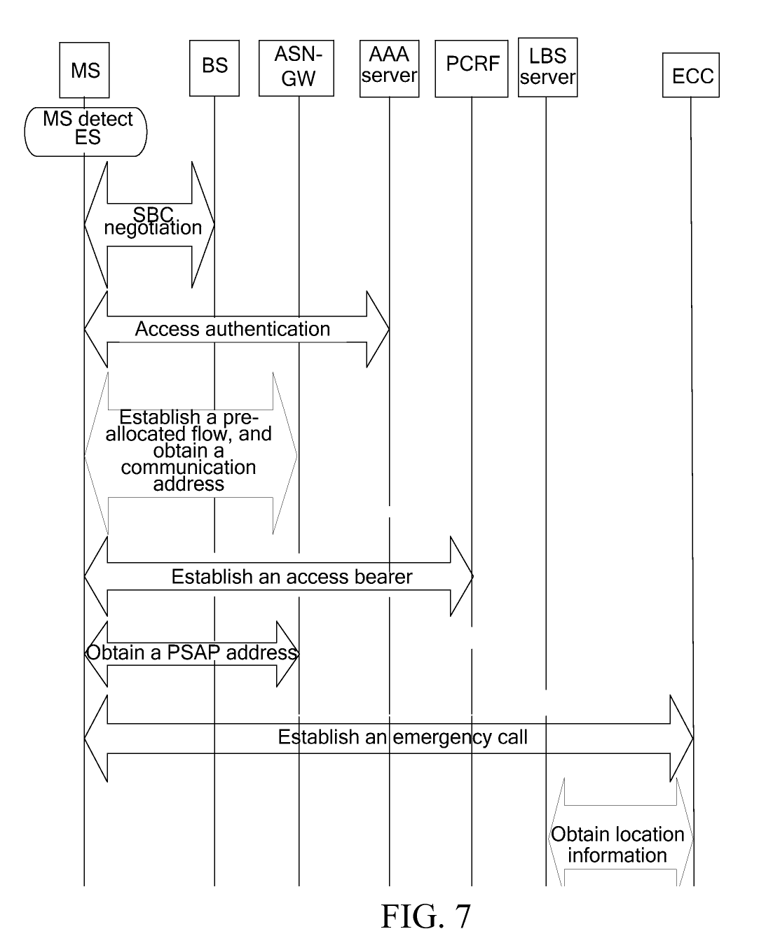

FIG. 7 is a processing flow chart of a third embodiment of the disclosure. In this embodiment, the user terminal establishes non-IMS emergency service processing based on the WiMAX network. This embodiment differs from the first and second embodiments in that, the user terminal does not adopt the IMS for emergency service call processing, but directly uses application layer signaling to perform interactions with the PSAP, so as to establish an emergency service. In the specific implementation of this embodiment, the network access process of the user terminal is similar to that of the above embodiments, so that the details are not described herein again. An access point address delivered by the network side is directly PSAP address information, and the PSAP address information can be obtained in the following two modes.

Mode 1: The PSAP address is pre-provisioned in the ASN-GW, and the user terminal obtains the PSAP address of the local network through a DHCP process. Upon detecting an emergency service flow, the ASN-GW forwards the emergency service flow to the PSAP in the local network according to the pre-provisioned PSAP address.

Mode 2: If the AAA server performs an access authentication on the user terminal, the AAA server delivers the PSAP address of the local network to the ASN-GW after completing the authentication on the user terminal, and the user terminal obtains the PSAP address of the local network through the DHCP process subsequently.

The user terminal initiates an emergency service call to the PSAP over the WiMAX network according to the obtained PSAP address. If the ASN-GW does not report the location information of the user terminal to the PSAP, the PSAP further needs to trigger the LBS server to locate the user terminal. Then, the LBS server locates the user terminal, and reports location information to the PSAP, so that the PSAP provides emergency service aids for the user terminal according to the location information of the user terminal.

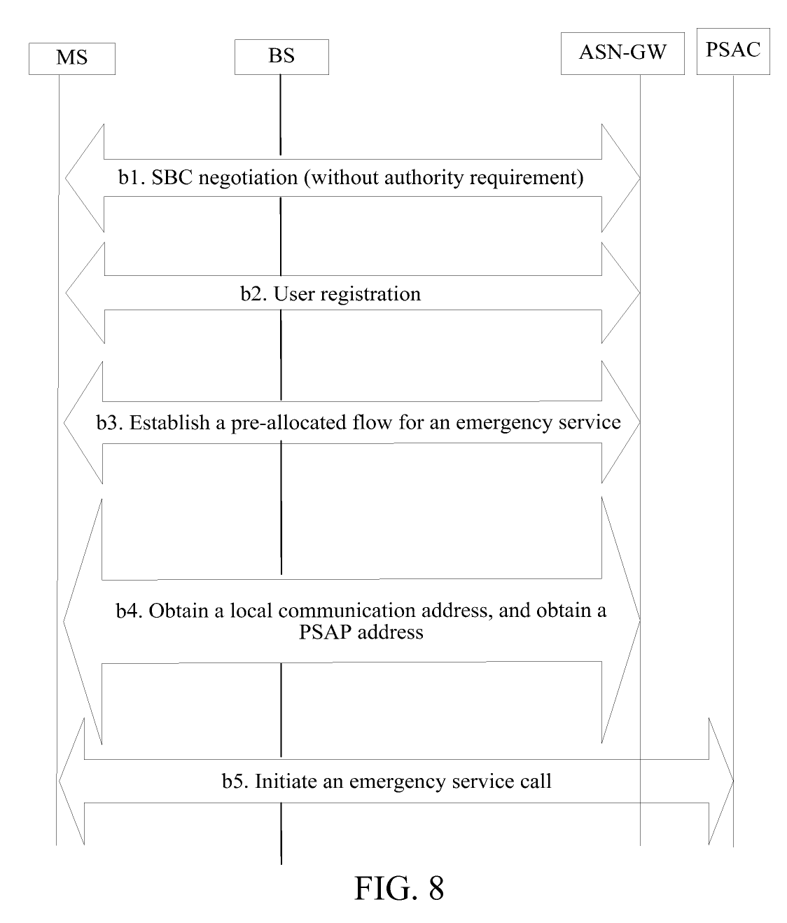

FIG. 8 is a processing flow chart of a fourth embodiment of the disclosure. In this embodiment, the ASN directly provides emergency service support for the user terminal, and the illustrative implementation is as follows.

In step b1, when accessing the network, the user terminal sends an SBC message carrying an emergency service indication to inform the network side to establish an air-interface connection based on an emergency service. After identifying the emergency service indication, the network side may not perform an authentication on the user and/or user terminal, but directly allow the user to access.

In step b2, the user initiates a normal registration process, and after the registration process is completed, the network side initiates an establishment of a pre-provisioned flow for the emergency service according to configuration information. As the network side has already known that the user accesses the network in case of an emergency, the following steps b3, b4, and b5 can be combined. The ASN-GW may act as an agent of the user to apply for an IP address, or directly allocate an IP address for the user. As the emergency service is provided by the ASN for the user terminal, the ASN may select an appropriate PSAP for the user according to an access point address allocated for the user. Furthermore, a default policy may be configured on the DPF, which allows all the user terminals to communicate with the PSAP, and a charging policy of no charge is prescribed on a charging client, so that the charging client does not charge the emergency service.

In step b3, the ASN-GW establishes the pre-provisioned flow for the user terminal that initiates an emergency service call. The pre-provisioned flow is adapted to bear emergency service signaling, and in addition the pre-provisioned flow may be further adapted to bear emergency service data.

In step b4, the user terminal respectively obtains IP address information of the user terminal itself in the local network and the PSAP address information from the ASN-GW through a DHCP process based on the established pre-provisioned flow.

In step b5, the user terminal establishes communication with the PSAP through the established pre-provisioned flow based on the obtained PSAP address. (For a valid user terminal that has accessed the network, the process of initiating an emergency service call when encountering an emergency situation may start from this step.)

If this process does not involve an interaction on the application layer, the user terminal may directly initiate the establishment of a service flow, or the SFA may initiate the establishment of a service flow for bearing the emergency service data.

If this process involves an interaction on the application layer, the SFA needs to establish a new access bearer for bearing the emergency service data for the user terminal according to the priority and QoS information delivered by the PCRF.

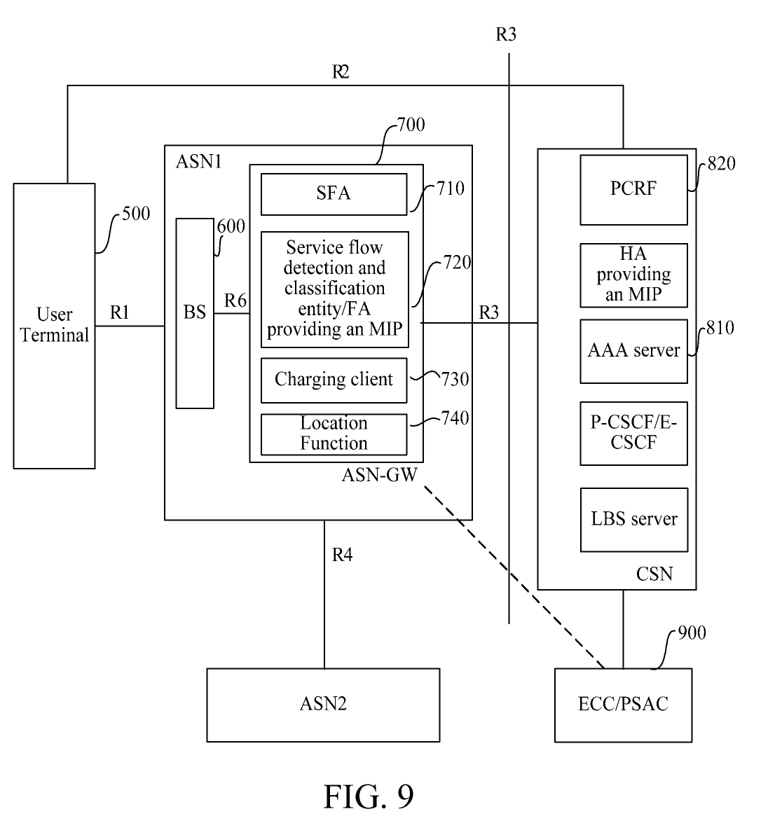

FIG. 9 is a block diagram of a structure of a WiMAX network system applying the method of the disclosure. Referring to FIG. 9, a user terminal 500 initiates a network access and initiates an emergency call when encountering an emergency situation. The user terminal 500 includes:

a unit adapted to send a message carrying an emergency service indication to a WiMAX network side;

a unit adapted to request the WiMAX network side for address information based on a bearer link for bearing emergency service signaling established by the WiMAX network side; and

a unit adapted to initiate an emergency call to an apparatus providing a local network emergency service (for example, an ECC/PSAC shown in FIG. 9) according to an access point address to the apparatus providing a local network emergency service delivered by the network side and based on a communication address allocated by the network side and the established bearer link for bearing the emergency service signaling and the emergency service data.

An ASN further includes a BS 600 and an ASN-GW 700. The BS 600 is adapted to control an SBC negotiation process and an air-interface connection establishment process of the user terminal. An SFM in the ASN controls the creation and modification of a service flow according to air-interface and scheduling resources. The BS 600 includes:

a unit adapted to detect whether a inter-area handover of a user terminal that sends an emergency service indication occurs during the communication between the user terminal and an apparatus providing a local network emergency service in a WiMAX network;

a unit adapted to obtain address information of a target BS when it is detected that a inter-area handover occurs; and

a unit adapted to transfer emergency service information of the user terminal to the target BS according to the obtained address information of the target BS.

The BS 600 may further include:

a unit adapted to detect whether a user terminal that sends an emergency service indication enters an idle mode or not during the communication with an apparatus providing a local network emergency service in a WiMAX network; and

a unit adapted to transfer emergency service information of the user terminal to an anchor PC when it is detected that the user terminal enters the idle mode.

The ASN-GW 700 in the ASN is adapted to perform an authentication on the user, and control establishment, modification, and removal of an access session and a bearer thereof. The ASN-GW 700 specifically includes:

a unit adapted to establish a bearer link for bearing emergency service signaling and emergency service data for a user terminal after the WiMAX network receives a message carrying an emergency service indication sent by the user terminal, where the unit may establish a bearer link with a corresponding performance according to QoS and priority information delivered by a PCRF 820 in a CSN, and this functional unit is mainly integrated in an SFA 710 that may be further adapted to perform authorization on a data stream and request for PCC rules or receive PCC rules;

a unit adapted to obtain a local network communication address allocated for the user terminal after receiving an address request sent by the user terminal; and

a unit adapted to deliver to the user terminal the obtained local network communication address and an access point address to an apparatus providing a local network emergency service based on the bearer link for bearing the emergency service signaling.

The ASN-GW 700 may further include a unit adapted to perform an authentication on the user and/or user terminal that sends an emergency service indication.

The ASN-GW 700 may further include a DPF 720, a charging client 730, and a location function 740.

The DPF 720 is adapted to detect and classify data streams, so that only emergency data streams are enabled to pass through a preset service flow and a pre-provisioned flow.

The charging client 730 is adapted to charge a user that initiates an emergency service call according to charging rules delivered by the PCRF 820 in the CSN.

The location function 740 is adapted to locate the user terminal and provide location information of the user terminal.

The CSN includes an AAA server 810 and the PCRF 820. The AAA server 810 is adapted to perform authentication and authorization on a user and/or user terminal that accesses the network in case of an emergency, and allocate an HA address and a P-CSCF address in a local visited network for the user. The AAA server 810 specifically includes:

a unit adapted to perform an authentication on a user terminal that sends an emergency service indication in a WiMAX network; and

a unit adapted to allocate a local network communication address for the user terminal that passes the authentication.

The PCRF 820 is adapted to: generate PCC rules according to a prescribed emergency service processing policy based on emergency service information and user information sent by a user terminal, and deliver the generated PCC rules to the ASN-GW 700. The PCRF 820 specifically includes: a unit adapted to generate attribute rules corresponding to an emergency service after receiving a message carrying an emergency service indication sent by a user terminal in a WiMAX network; and a unit adapted to deliver the generated attribute rules to the ASN-GW 700. The attribute rules generated by the PCRF 820 include at least one selected from a group consisting of QoS of a bearer link established for the user terminal, priority rules, charging rules, and service flow detecting rules.

In addition, the WiMAX network side may further include an LBS server. The LBS server includes:

a unit adapted to locate the user terminal 500 when the user terminal 500 initiates an emergency call to an ECC/PSAC 900 in the WiMAX network;

and a unit adapted to provide obtained location information for the ECC/PSAC 900.

The functional units configured in the above apparatuses such as the user terminal 500, the BS 600, the ASN-GW 700, the AAA server 810, the PCRF 820, and the LBS server for realizing the technical solutions of the disclosure can be realized by software programs or by making improvements and upgrading the existing hardware capability.

If the user terminal has successfully accessed the network in the radio network system, the user terminal directly sends a message carrying an emergency service indication to the radio network side when encountering an emergency situation. The radio network side receives the message carrying the emergency service indication sent by the user terminal, and then informs the user terminal of an access point address to an apparatus providing a local network emergency service. After receiving the access point address, the user terminal realizes communication with the apparatus providing a local network emergency service according to the access point address delivered by the network side based on a local network communication address obtained by the user terminal itself and a service flow established during the network access registration that serves as a bearer link for bearing an emergency service message.

The local network communication address obtained by the user terminal may be a communication address for normal communication services allocated by the network side for the user terminal during the network access registration of the user terminal. In this case, the user terminal continues using the IP address of the original normal services, and establishes a dedicated tunnel with the PSAP after an Anchor DPF detects the emergency service, so as to realize communication with the PSAP through the tunnel.

The local network communication address obtained by the user terminal may be a communication address exclusively directed to emergency communication services allocated by the network side for the user terminal during the network access registration of the user terminal. In this case, the user terminal may obtain a plurality of IP addresses during the network access registration, among which one IP address is exclusively adapted to process the emergency service communication and is selectively used by the user terminal or the network side (PCRF/CSCFs/PSAP) when the user terminal initiates an emergency service.

Furthermore, the user terminal includes: a unit adapted to send a message carrying an emergency service indication to a radio network side; a unit adapted to receive an access point address to an apparatus providing a local network emergency service informed by the radio network side to the user terminal after the radio network side receives the message carrying the emergency service indication sent by the user terminal; and a unit adapted to realize communication with the apparatus providing a local network emergency service according to the access point address delivered by the network side and based on the obtained local network communication address and a service flow established during the network access registration that serves as a bearer link for bearing an emergency service message. Such a user terminal still falls within the protecting range of the disclosure.

In view of the above, through the embodiments of the disclosure, in a WiMAX network system, a user terminal can initiate an emergency call based on the WiMAX network when encountering an emergency situation despite whether the user terminal has accessed the network and become a valid user or not, so as to establish communication with an apparatus capable of providing an emergency service in the local network (for example, a PSAP/ECC) and thus get corresponding emergency aids. Of course, the embodiments of the disclosure are applicable to other wireless communication systems, for example, GSM communication system, CDMA communication system, and subsequent evolution systems of W-CDMA communication system such as EDGE, UMB, and LTE.

It will be apparent to those skilled in the art that various modifications and variations can be made to the structure of the disclosure without departing from the scope or spirit of the invention. In view of the foregoing, it is intended that the disclosure cover modifications and variations of this invention provided they fall within the scope of the following claims and their equivalents.

What is claimed is:

1. A method for realizing emergency communication, comprising:
receiving, by a radio network side, a message carrying an emergency service indication sent by a user terminal;
establishing a bearer link for bearing emergency service signaling and emergency service data for the user terminal;
receiving, by the network side, an address obtaining request sent by the user terminal based on the bearer link for bearing the emergency service signaling;
delivering to the user terminal a local network communication address allocated for the user terminal and an access point address to an apparatus providing a local network emergency service based on the bearer link for bearing the emergency service signaling; and
communicating, by the apparatus providing a local network emergency service on the network side, with the user terminal based on the established bearer link.

2. The method of claim 1, further comprising:
sending, by an authenticator on the radio network side, an Extensible Authentication Protocol-Identity (EAP-Identity) request to the user terminal;
receiving the emergency service indication sent according to the EAP-Identity request by the user terminal;
determining, by the authenticator, whether to perform authentication on the user terminal and/or user after identifying the emergency service indication sent by the user terminal.

3. The method of claim 1, further comprising:
sending, by an authenticator on the radio network side, an Extensible Authentication Protocol-Identity (EAP-Identity) request to the user terminal;
reporting to an authentication, authorization, and accounting (AAA) server an access request carrying the emergency service indication sent according to the EAP-Identity request by the user terminal; and
determining, by the AAA server, whether to perform authentication on the user terminal and/or user after identifying the emergency service indication carried in the access request sent by the user terminal.

4. The method of claim 1, wherein the access point address is an address of a proxy-call session control function (P-CSCF) or an address of a public safety access point (PSAP) in the local network.

5. The method of claim 1, wherein the apparatus providing a local network emergency service communicates with the user terminal based on an access service network (ASN) or a connect service network (CSN) on the radio network side.

6. The method of claim 1, further comprising:
locating the user terminal, by a location based services server (LBS server), on the radio network side, when the user terminal initiates an emergency call to the apparatus providing a local network emergency service; and
reporting location information to the apparatus providing a local network emergency service.

7. The method of claim 1, further comprising:
transferring, by a serving base station (BS) on the radio network side, emergency service information of the user terminal to a target BS when an inter-area handover occurs during the communication between the user terminal and the apparatus providing a local network emergency service.

8. The method of claim 1, further comprising:
transferring, by a serving base station (BS) on the radio network side, emergency service information of the user terminal to an anchor paging controller (PC) when the user terminal enters the idle mode during the communication between the user terminal and the apparatus providing a local network emergency service.

9. A method for realizing emergency communication comprising:
sending a message carrying an emergency service indication to a radio network side;
requesting the radio network side for address information based on a bearer link for bearing emergency service signaling established by the radio network side, according to the message carrying the emergency service indication;
initiating an emergency call to an apparatus providing a local network emergency service according to an access point address to the apparatus providing a local network emergency service delivered by the radio network side and based on a communication address allocated by the radio network side and the established bearer link for bearing the emergency service signaling and emergency service data.

10. The method of claim 9, wherein the emergency service indication is carried in a subscriber basic capability (SBC) message sent to the radio network side during an SBC negotiation process with the radio network side.

11. The method of claim 9, further comprising:
identifying the emergency service indication based on high bits in a service flow identifier (SFID).

12. A user terminal, comprising:
a unit adapted to send a message carrying an emergency service indication to a radio network side;
a unit adapted to request the radio network side for address information based on a bearer link for bearing emergency service signaling established by the radio network side; and
a unit adapted to initiate an emergency call to an apparatus providing a local network emergency service according to an access point address to the apparatus providing a local network emergency service delivered by the radio network side and based on a communication address allocated by the radio network side and the established bearer link for bearing the emergency service signaling and emergency service data.

13. The user terminal of claim 12, wherein the unit adapted to send the emergency service indication carries the emergency service indication in a subscriber basic capability (SBC) message sent to the radio network side during an SBC negotiation process between the user terminal and the radio network side.

14. The user terminal of claim 12, wherein the unit adapted to send the emergency service indication identifies the emergency service indication based on high bits in a service flow identifier (SFID).

15. A system for realizing an emergency communication service, comprising:
a unit adapted to establish a bearer link for bearing emergency service signaling and emergency service data for a user terminal, after receiving a message carrying an emergency service indication sent by the user terminal;
a unit adapted to allocate a local network communication address for the user terminal, after receiving an address request sent by the user terminal; and
a unit adapted to deliver to the user terminal the local network communication address allocated for the user terminal and an access point address to an apparatus providing a local network emergency service based on the established bearer link for bearing the emergency service signaling.

16. The system of claim 15, further comprising a user terminal, wherein the user terminal is adapted to
send the message carrying an emergency service indication,
request for address information based on the bearer link for bearing emergency service signaling established according to the message carrying an emergency service indication, and
initiate an emergency call to the apparatus providing a local network emergency service according to the access point address to the apparatus providing a local network emergency service and based on the allocated communication address and the established bearer link for bearing the emergency service signaling and emergency service data.

17. The system of claim 15, further comprising a unit adapted to perform authentication and authorization on the user terminal and/or user.

18. The system of claim 15, further comprising a unit adapted to locate the user terminal when the user terminal initiates an emergency call to the apparatus providing a local network emergency service, and report location information to the apparatus providing a local network emergency service.

19. An access service network gateway, comprising:
a unit adapted to establish a bearer link for bearing emergency service signaling and emergency service data for a user terminal after a radio network receives a message carrying an emergency service indication sent by the user terminal;
a unit adapted to obtain a local network communication address allocated for the user terminal after receiving an address request sent by the user terminal; and
a unit adapted to deliver to the user terminal the obtained local network communication address and an access point address to an apparatus providing a local network emergency service based on the established bearer link for bearing the emergency service signaling.

20. The gateway of claim 19, wherein the unit adapted to establish a bearer link establishes a bearer link with a corresponding performance according to QoS and priority information delivered by a policy control and charging rules function.
